(19) United States
(12) Patent Application Publication
(10) Pub. No.: US 2007/0125798 A1
(43) Pub. Date: Jun. 7, 2007

(54) Spray booth and method for coating the human body with sunscreen or the like

(76) Inventor: Kent McGuire, Myrtle Beach, SC (US)

Correspondence Address: MCDERMOTT, WILL & EMERY LLP, 227 WEST MONROE STREET, CHICAGO, IL, 60606-5096, US

(21) Appl. No.: 11/607,646

(22) Filed: Dec. 1, 2006

Related U.S. Application Data
(60) Provisional application No. 60/597,454, filed on Dec. 2, 2005.
(60) Provisional application No. 60/767,400, filed on Mar. 24, 2006.

(51) Int. Cl. B67D 5/30; G06Q 30/00

(52) U.S. Cl. 222/14; 705/1

(57) ABSTRACT

A low voltage, portable, outdoor spray system for applying sunscreen to a user. The system is comprised of a booth having a floor and at least one wall defining an enclosure. At least one spray nozzle is positioned within the enclosure and is connected to a pump. The pump in turn is connected to a reservoir tank, which may hold a sunscreen lotion, a tanning lotion or a aloe vera lotion. The spray system also includes an automated payment system. Once payment has been verified, a microcontroller sends a signal to the pump to begin operation. The pump draws lotion from the reservoir tank and delivers the lotion to a check valve. Upon reaching a predetermined pressure, the check valve opens and releases the lotion through the spray nozzle and onto the user.

### CROSS REFERENCE TO RELATED APPLICATIONS

This application claims priority to Provisional Patent Application No. 60/597,454, filed on Dec. 2, 2005 and Provisional Patent Application No. 60/767,400, filed on Mar. 24, 2006. Priority to these applications is claimed under 35 U.S.C. § 119 and/or § 120, and the disclosure of these applications is incorporated herein by reference in their entirety.

### TECHNICAL FIELD

The present invention generally relates to an apparatus and method for coating the human body with sunscreen or the like. Specifically, the invention relates to a portable spray booth that has a low voltage pump for spraying a wet application of sunscreen lotion, tanning lotion and/or a cosmetic skin lotion upon a user.

### BACKGROUND OF THE INVENTION

It is well known that overexposure to the sun's invisible rays—ultraviolet A (UVA) and ultraviolet B (UVB)—can cause skin damage. The damage can be immediate and long-term, with effects ranging from sunburn, rashes, and cell and tissue damage to premature wrinkling and skin cancer. In fact, many skin changes that often are identified with aging actually result from damage by too much sun.

One common way people protect themselves from the harmful effects of the sun is the application of sunscreen or sunblock lotion to the skin. Sunscreen or sunblock is generally a lotion, spray or other topical solution that helps protect the skin from the sun's UV radiation. Sunscreen or sunblock reduces sunburn and other skin damage, ultimately leading to a lower risk of skin cancer. Most sunscreens work by containing an organic chemical compound that absorbs UV light, for example oxybenzone, or an opaque material that reflects light, for example titanium dioxide or zinc oxide, or a combination of both. Typically, absorptive materials are referred to as chemical blocks, whereas opaque materials are mineral or physical blocks.

The amount of UV light protection that a sunscreen or sunblock provides depends on a number of factors, including: the amount of sunscreen applied to a particular area, the environment the sunscreen will be exposed to (for example submerged in water or exposed to sweat), frequency of the application and the sun protection factor (SPF) of the lotion being applied. Sunscreen lotions are rated on a scale ranging from as low as 2 to as high as 60. These ratings refer to the lotion's ability to screen or block out the sun's UV rays and is determined by comparing the amount of time needed to produce a sunburn on protected skin to the amount of time needed to cause a sunburn on unprotected skin. The greater the SPF rating, the greater protection that sunscreen lotion provides to the user. Sunscreens with an SPF rating of 15 or higher are generally thought to provide useful protection from the sun's harmful UV rays.

Today sunscreen lotion is commonly available in small packages (typically 4 to 10 ounces in a bottle or tube), which can be purchased from grocery stores, convenience stores, gas stations, etc. When a person plans to spend an extended period of time in the sun (for example at the beach, a pool, a park, etc.) they typically purchase a bottle or tube or sunscreen and apply it by squeezing or pumping the lotion directly onto the skin or by applying the lotion onto their hands, and then rubbing the lotion onto their skin. One problem associated with this method of applying sunscreen is that an individual may have difficulty applying the sunscreen to certain body parts or may apply the sunscreen unevenly. This results in an uneven tan or exposure of certain areas to the sun's harmful UV rays.

Other problems exist with this manual method of applying sunscreen. For example, individuals often forget to bring sunscreen with them to a pool, beach or park. Rather then taking the time to purchase sunscreen from a store, many individuals will simply go without sunscreen, exposing themselves to the potentially harmful UV rays. In addition to applying sunscreen, some individuals may find it desirous to apply cosmetic lotions while sunbathing. This requires additional bottles and/or tubes and application of these lotions suffer from the same coating problems as described above. Moreover, at a location with sand or particles, for example a beach, the sunscreen bottles and tubes will invariably pick up sand or other particles. Application of the contaminated lotion causes irritation of the skin, and may lead to incomplete or uneven application of the sunscreen lotion.

A number of booths exist that allow for automated application of a sunscreen or sun tanning lotion. These existing booths can be separated into two categories: those designed for indoor use and those designed for outdoor use. Examples of booths designed for indoor use are commonly used to apply sun tanning lotion to a user and can be found indoors at tanning spas. Examples of such booths include those disclosed in U.S. Pat. Nos. 5,460,192, 5,664,593 5,922,333 and 7,082,948. User access to such booths is generally monitored by an employee working at the spa. Further, because such booths are located indoors, the materials and components are not ideal for withstanding outdoor environments. Because these booths are typically installed indoors, they are not designed to be portable. They also use a high voltage power system, something not well suited to outdoor locations near the water, for example poolside at a resort or near the beach. For tanning application booths, the drying process of the applied lotion is as equally as important as the application process. Accordingly, some of the existing systems utilize an air compressor that (along with the nozzle spray components) atomizes the lotion resulting in a “dry lotion application.” In addition, some of these systems include exhaust fans to increase air flow within the coating chamber to enhance the drying process, improve exhaust flow and minimize the user's exposure to breathing the atomized lotion.

Several booths have been proposed for outdoor use but suffer from deficiencies that limit their overall effectiveness. For example, U.S. Pat. No. 6,918,897 and International Application No. PCT/US2006/009561 disclose sunscreen spray booths for outdoor use. These booths, however, utilize pump systems that either inject air into the lotion via an air compressor to atomize the lotion, resulting in a dry lotion application[[, or the pump systems are not especially well suited for outdoor use]]. Another deficiency is that the pumps employed in these booths are not well-suited for outdoor use because they leave excess lotion in the supply lines/conduits. As a result of being used outdoors and exposed to outside temperature extremes with many different climates and high pressures, the excess lotions have a tendency to re-precipitate. That is, the raw materials or components blended together to make up the lotion, revert back to their original state and separate out from the blend. This causes build up within the system causing blockage of supply lines and/or nozzles and harm to the pump. Thus, a need still exists for an economically efficient, portable outdoor spray system that utilizes an efficient pump system for effectively applying sunscreen or the like to a user.

### SUMMARY OF THE INVENTION

The present invention is related to a portable, outdoor spray system for applying sunscreen to a user. In one embodiment, the system is comprised of a booth having a floor and at least one wall defining an enclosure. A spray nozzle is positioned within the enclosure and is connected to a pump. The pump in turn is connected to a reservoir tank. The spray system also includes an automated payment system. Once payment has been verified, a microcontroller sends a signal to the pump to begin operation. The pump draws lotion from the reservoir tank and delivers the lotion to a check valve. Upon reaching a predetermined pressure, the check valve opens and releases the lotion through the spray nozzle and onto the user. At no time is air introduced into the lotion. Accordingly, only a small amount of atomization of the lotion occurs as it is sprayed through the nozzle onto the user. Unlike many prior spray systems that premix the lotion with air via a compressor, the small amount of atomization as a result of forcing the lotion through the nozzle orifice results in a wet application in the present invention that gives the user the feeling of applying lotion or sunscreen from a bottle or tube.

In another embodiment of the present invention, the pump used in the spray system is a diaphragm pump and the check valve is activated (i.e., open and closed) in response to a signal from a solenoid. This combination allows the pump to move lotion from the reservoir tank through the supply lines to the check valve. Upon reaching a predetermined pressure, the check valve opens, releasing the lotion through the spray nozzle and onto the user. The flow of lotion to the spray nozzle is stopped by closing the check valve. This occurs as a result of the microprocessor sending a signal to the solenoid. Once the check valve is closed, the diaphragm pump sucks the lotion out of the supply lines and back into the reservoir tank. Accordingly, lotion does not remain in the supply lines between uses, exposed to extreme temperature variations that could lead to build-up in the system.

Still other advantages of various aspects of the invention will become apparent to those skilled in the art from the following description wherein there are shown and described exemplary embodiments of this invention for the purposes of illustration.

### BRIEF DESCRIPTION OF THE DRAWINGS

While this invention is susceptible of embodiments in many different forms, there is shown in the drawings and will herein be described an example of the invention with the understanding that the present disclosure is to be considered as an exemplification of the principles of the invention and is not intended to limit the broad aspect of the invention to the examples illustrated.

FIG. 1 is a perspective view of a sunscreen spray booth according to one embodiment of the present invention.

FIG. 2 is a top view of a sunscreen spray booth according to another embodiment of the present invention.

FIG. 3 is a top view of a sunscreen spray booth according to another embodiment of the present invention.

FIG. 4 is a schematic diagram of the control system and pump system for a spray booth according to another embodiment of the present invention.

FIG. 5 illustrates how a diaphragm pump draws sunscreen lotion from a reservoir tank and delivers the lotion to a solenoid activated check valve according to the present invention.

FIG. 6 illustrates how, when the solenoid activated check valve is closed, a diaphragm pump is able withdraw excess lotion from the line and return it to the reservoir tank.

FIG. 7 is a schematic diagram showing a pumping and spray system according to a preferred embodiment of the present invasion.

FIG. 8 is a schematic diagram showing a pumping and spray system according to another embodiment of the present invention.

### DETAILED DESCRIPTION

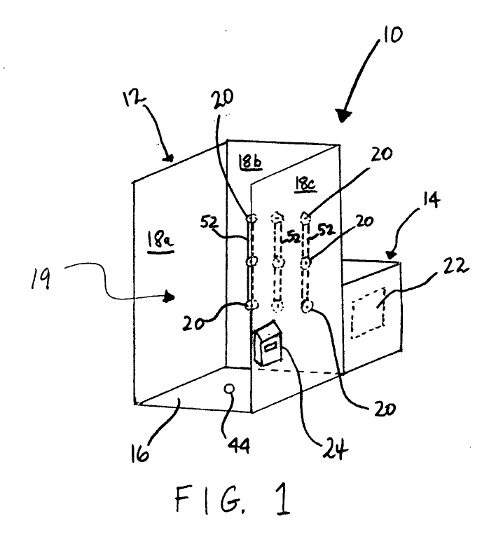

FIG. 1 illustrates a sunscreen spray system 10 of the present invention. Generally, the system 10 is comprised of a spray booth 12 and a component cabinet 14. The booth 12 has a floor 16 and at least one wall defining an enclosure. In the FIG. 1, the booth 12 is comprised of three walls: a first side wall 18a, a back wall, 18b and a second side wall, 18c. The walls 18a, 18b, 18c define an enclosure that make up the spray area of the system 10. A spray nozzle 20, or a plurality of spray nozzles 20 are positioned within the enclosure. In FIG. 1, the plurality of nozzles 20 is attached to the back wall 18b of the booth 12. A pump system 22, which is described more fully below, is positioned in the cabinet 14 and is connected to the spray nozzles 20. The pump system 22 is responsible of delivering sunscreen from a reservoir tank through the nozzles 20 to a user standing in the enclosure. The system 10 includes an automatic payment acceptance system 24 that includes a typical vending currency acceptor and a wireless transmitter for accepting electronic payments from debit and credit cards. The automatic payment acceptance system 24 is preferably connected to the outside of one of the walls of the booth 12. The pump system is powered by a low voltage power source and controlled by a microprocessor 50.

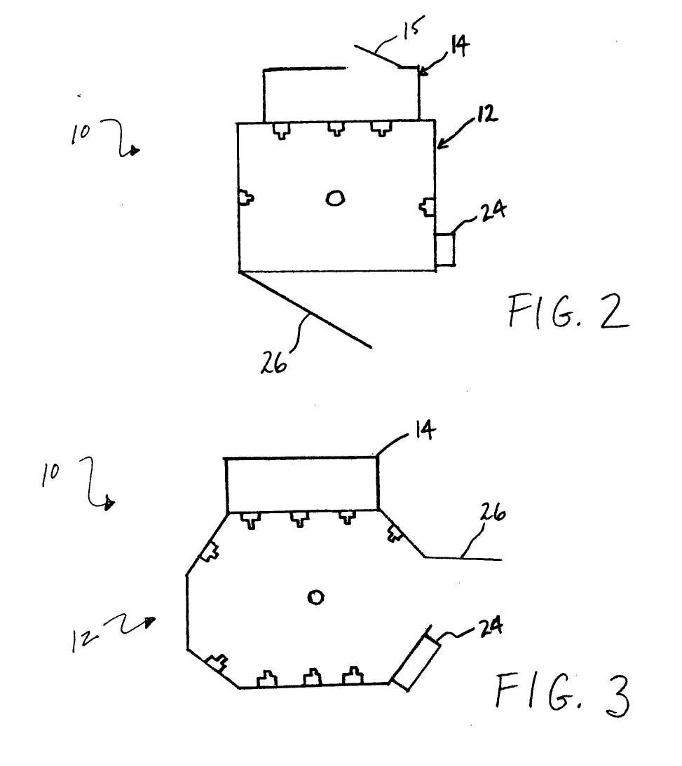

As shown in FIGS. 1-3, the booth 12 can take many different forms. In its simplest form, the booth 12 is comprised of three walls 18a, 18b and 18c as disclosed in FIG. 1. There is no door. A user simply makes the appropriate payment at the automatic payment acceptance system 24 and walks into the enclosure created by the walls 18a, 18b and 18c. However, the shape of the booth 12 can take many different forms and sizes. FIGS. 2 and 3 show preferred embodiments wherein the booth 12 includes a door 26. In FIG. 2, the booth 12 is square or rectangular in shape. Preferably the booth 12 is approximately 48″ by 42″ and the walls 18a-c are 96″ high. The component cabinet 14 is approximately 24″ by 30″ by 80″. In FIG. 3, the booth takes the shape of an octagon. Preferably the component cabinet 14 has a door or access panel to allow access to the pump system 22 for maintenance and repair.

The spray booth 12 is a free standing unit which is formed from materials that are waterproof and engineered for outdoor use. The booth 12 has a molded fiberglass base and aluminum rails forming a frame. The walls 18a, 18b and 18c are formed from a cell cast acrylic sheet. The base or floor is covered with a starboard non-slip material. The component cabinet 14 is also a free standing unit and is constructed from weatherproof starboard material.

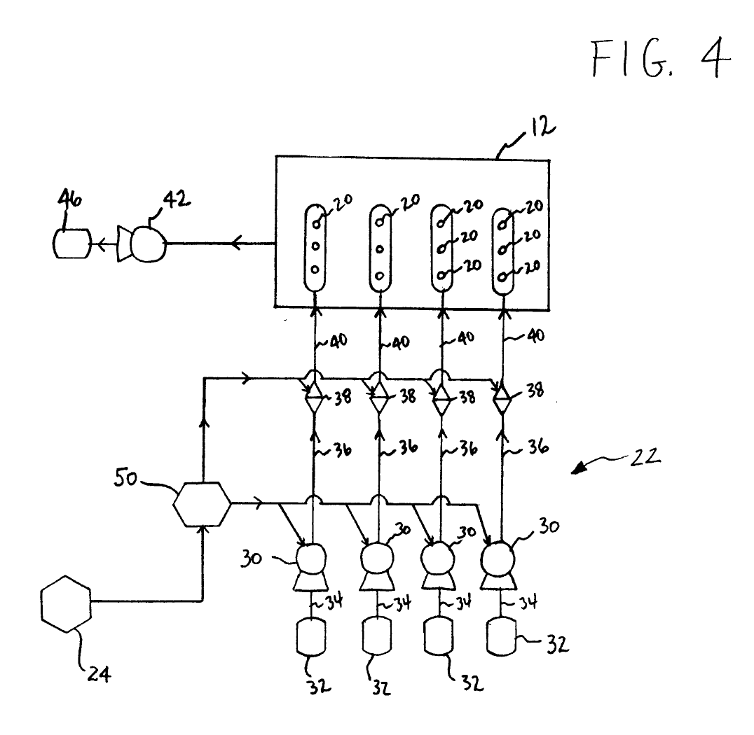

With reference to FIG. 4, the pump system 22 of the present invention will be explained in detail with reference to a preferred embodiment. The pump system 22 includes a plurality of pumps 30. Each pump 30 is connected to a respective reservoir tank 32 via supply line 34. Each pump 30 has an output line 36 that is connected to a check valve 38. The check valves 38 are connected via supply lines 40 to a plurality of nozzles 20 positioned within the booth 12. Another pump 42 is connected to a drain 44 located in the floor 16 of the booth 12 to remove any spent lotion from the booth 12. The spent lotion and/or waste is pumped into a collection tank 46.

Preferably, the reservoir tanks 32 hold one of the following solutions: a sunscreen lotion having an SPF rating of anywhere between 2 and 60, a tanning lotion, a moisturizing lotion, an aloe Vera lotion, a suntan lotion or oil, sunburn treatment lotions, exfoliants, nutriment or vitamin lotions, disinfectant, water and any combination thereof. In a preferred embodiment, One reservoir tank 32 holds a sunscreen lotion having an SPF rating in the range of 15-25. It has been found that sunscreen lotions that have been subjected to high-shear blending and/or mixing work best in the system 10 of the present invention. By subjecting the sunscreen lotion to high-shear mixing, the components of the sunscreen lotion (e.g., aloe vera, lipowax Pa., carbopol, benzophenone, octylmethycinnamate, parsol MCX, dimethicone and massage oil) become fully dissolved in the water base. This helps prevent re-precipitation of the lotion and reduces the likelihood of build-up in the pump system 22. A second reservoir tank 32 holds a tanning lotion, which preferably includes the component Unipertan which is tan accelerating ingredient composed of tyrosine, riboflavin and collagen. A third reservoir tank 32 holds a aloe vera lotion. Again, high shear mixing of the aloe vera lotion helps ensures that the components (e.g., aloe vera 40X, lipowax Pa., carbopol and massage oil) are completely dissolved in a water base. Again, this helps reduce breakdown and the lotion and build-up in the pump system 22. Finally, a fourth reservoir tank 32 holds water or water/disinfectant mixture to rinse down the inner walls of the spray booth 12. It should be understood that the as few as one reservoir tank/pump combination, and up to as many as desired, may be incorporated into a system 10 of the present invention. The reservoir tanks 32 and all necessary hardware are preferably comprised of aluminum and stainless steel.

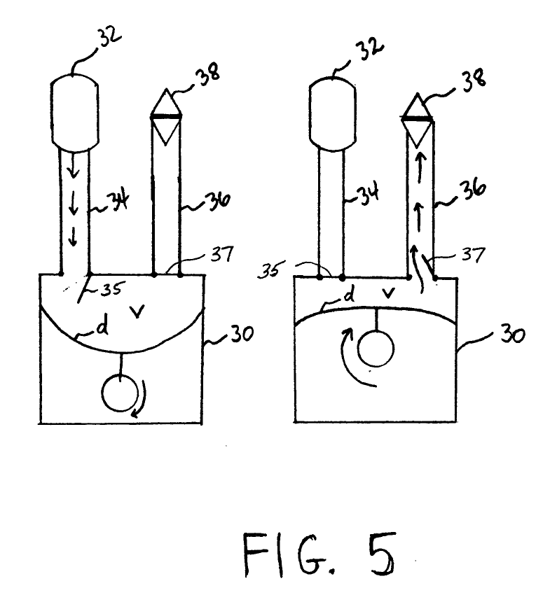

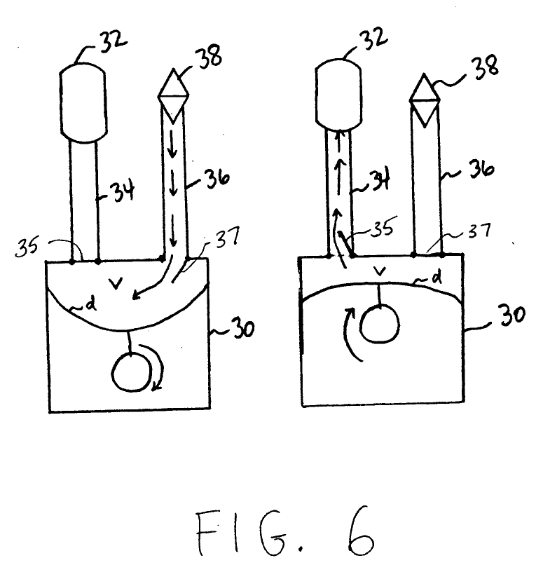

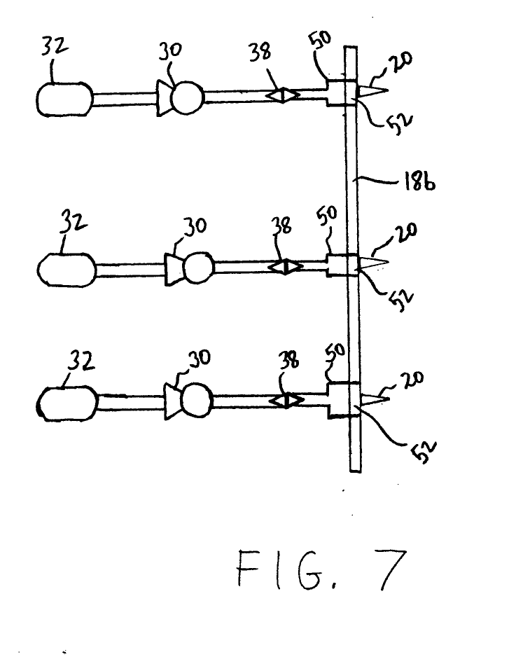

The pumps 30 are preferably diaphragm pumps. The general operation of a diaphragm pump 30 and the associated benefits of using diaphragm pumps 30 in the system 10 of the present invention will be described in detail with reference to FIGS. 5 and 6. A diaphragm pump is a positive displacement pump that uses a combination of reciprocating action of a rubber or Teflon diaphragm and check valves to pump a fluid as is well known in the art. Diaphragm pumps 30 that are especially well suited for use in the present invention are those that have open flow valves on the pump head that allow for reverse flow of the fluid. In an especially preferred embodiment, a 24 volt DC, 8000 Series diaphragm pump manufactured by SHURflo Pump Manufacturing Company of Cypress, Calif. is used in the pump system 22 of the present invention.

As shown in FIG. 5, as the diaphragm, d, is flexed, causing the volume, v, of the pump chamber to increase, the pressure decreases and fluid is drawn into the pump chamber from reservoir tank 32. During this step the valve on the pump that is connected to supply line 34 is open and the valve on the pump head connected to output line 36 is closed. When the diaphragm, d, is again flexed, causing the volume, v, of the pump chamber to decrease, the pressure increases and fluid is forced out to the check valve 38. Here, the valve connected to output line 36 is open and the valve connected to input line 34 is closed. Upon receiving a signal from microprocessor 50, the solenoid check valve 38 opens and releases the fluid to the nozzle 20. Alternatively, once a predetermined pressure is achieved, e.g., 40 psi, the check valve 38 may automatically open.

The flow of fluid to the nozzle 20 (and accordingly into the spray booth) is stopped when the solenoid check valve 38 receives another signal from microprocessor 50. Once the spray application is complete, and with the solenoid controlled check valve 38 closed, the diaphragm, d, flexes, increasing the pump chamber volume and drawing the fluid back out of the output line 36 and into the pump chamber. Here, the valve on the pump head connected to output line 36 is open and the valve connected to input line 34 is closed. When the diaphragm, d, flexes again, decreasing the volume, v, of the pump chamber, the retrieved fluid is forced out of the pump chamber and back into the reservoir tank. In this instance, the valve on the pump head connected to supply line 34 is open and the valve on the pump head connected to output line 36 is closed.

A preferred method of operating the system 10 of the present invention will now be explained with reference to FIGS. 1-5. Upon verification of payment, the payment acceptance system 24 sends a signal to the microprocessor 50. The microprocessor signals one of the pumps 30 connected to a reservoir tank 32 holding a rinse solution of water or a mixture of water and a disinfectant. Accordingly, before the user steps into the spray booth 12, the systems employs a self cleaning rinse. Then using a customer interface system (which can be located inside or outside the spray booth) the user chooses the solution to be sprayed by pressing one of a plurality of buttons or touch pads associated with different solutions. The user may have his/her choice of SPF sunscreen lotions, cosmetic lotions, moisturizing lotions, tanning sprays, aloe vera lotions, etc. Based on the users choice, the microprocessor 50 sends a signal to the pump 30 associated with the solution chosen by the user. The signaled pump 30 begins operating by drawing solution from the reservoir tank 32 associated with the “live” pump 30. There will generally be a five second delay before the system 10 begins spraying solution through the nozzles 20 into the booth 12. The spraying will continue for approximately 3-5 seconds coating the front of the user with the product of their choice. At this point, the microprocessor 50 signals the solenoid check valve 38 associated with the appropriate pump 30 and output lines 36 and supply line 40. The valve 38 is closed, stopping the spray of the solution for approximately 5 seconds. The user then turns around placing his/her back towards the spray nozzles 20. Another signal from the microprocessor 50 opens the check valve 38 and spaying continues for another 3-5 seconds, coating the back of the user with the product of their choice. The session is now complete and the user may rub the wet lotion or solution into their skin and exit the spray booth.

In addition to have a self-cleaning rinse cycle, the system may also allow for the user to rinse his/her body prior to applying the desired product to their skin.

Turning now to FIGS. 6 and 7, the nozzles 20 of the present invention will be described in detail. At least one nozzle 20 each respective pump/reservoir/check valve assembly is positioned within the spray booth 12. Preferably the nozzles are full cone TG series jet nozzles manufactured by Spraying Systems Co. of Wheaton, Ill. A plurality of nozzles 20 may aligned on a single arm and connected to a manifold 50 which delivers the desired solution to the nozzles 20. For example, as shown in FIG. 7 a separate pump 30 supplies solution to a manifold 50 that distributes solution along an arm 52 and supplies the solution to the nozzles 20. FIG. 7 shows the top view of the back wall 18b of a spray booth lo having three separate arms 52 with a plurality of nozzles 20. As shown in FIGS. 1 and 7, the arms 52 may all be positioned on the back wall 18b of the spray booth 12. Or as shown in FIGS. 2 and 3 the arms 52 and associated nozzles 20 may be positioned on any number of walls defining the enclosed spray booth 12.

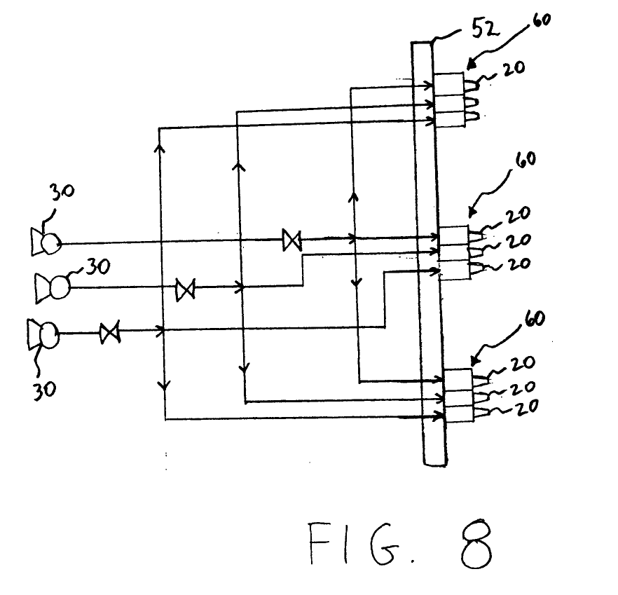

FIG. 8 discloses an alternative embodiment wherein a single arm 52 includes a plurality of nozzles 20. Rather than employ a manifold to distribute the fluid, a plurality of a cluster of nozzles 60 is positioned on arm 52. A single pump 30 supplies fluid to one nozzle 20 in each cluster 60. The pump 30 may also supply nozzles in other clusters 60 as well. In an alternate embodiment not disclosed in the drawings, a nozzle 20 or a plurality of nozzles 20 may be fixed on a hand held wand that the user can manually position during the spray session.

The automated payment system 24 is comprised of a typical vending currency system that accepts bills and coins and an electronic payment system which accepts credit cards, debit cards, magnetic strip cards that are associated with a particular room at a resort and contactless payments. The system 24 includes a wireless transmitter. One such example of a suitable electronic payment system is the Verifone QX720 which was built for outdoor environments and is weather proof.

In a preferred embodiment, the customer interface system contains a button which when pressed activates a recorded voice instruction for operation of the system 10. The interface system may also include recorded messages about the characteristics and/or benefits of the sun protection products available in the system 10.

While the foregoing has described what is considered to be the best mode and/or other examples, it is understood that various modifications may be made therein and that the subject matter disclosed herein may be implemented in various forms and examples, and that they may be applied in numerous other applications, combinations and environments, only some of which have been described herein. Those of ordinary skill in that art will recognize that the disclosed aspects may be altered or amended without departing from the true spirit and scope of the subject matter. Therefore, the subject matter is not limited to the specific details, exhibits and illustrated examples in this description. It is intended to protect any and all modifications and variations that fall within the true scope of the advantageous concepts disclosed herein.

I claim:

1. An apparatus for dispensing a lotion, the apparatus comprising:
a booth having a floor and at least one wall defining an enclosure;
a nozzle positioned within the enclosure;
a reservoir tank for holding the lotion;
means for receiving payment from a user;
a pump connected to the reservoir tank, the pump drawing lotion from the reservoir tank and transmitting the lotion to a check valve, the check valve opening upon reaching a predetermined pressure to deliver the lotion to the nozzle, wherein air is not introduced into the lotion prior to reaching the nozzle such that only partial atomization occurs when the lotion passes through the nozzle to apply a wet lotion upon the user; and
a low voltage power source connected to the pump.

2. The apparatus of claim 1, wherein the pump is comprised of a diaphragm pump.

3. The apparatus of claim 2 further comprising a microprocessor for controlling the operation of the diaphragm pump and the check valve.

4. The apparatus of claim 3, wherein the means for receiving payment from a user sends a signal to the microprocessor upon verification of payment and the microprocessor signals the diaphragm pump to begin operation.

5. The apparatus of claim 1, wherein the floor includes a drain connected to a collection tank.

6. The apparatus of claim 1, wherein the means for receiving payment from a user comprises a wireless transmitter.

7. The apparatus of claim 1, wherein the low voltage power source is comprised of solar energy.

8. The apparatus of claim 2, wherein the low voltage power source is a DC power supply.

9. The apparatus of claim 1 further comprising a plurality of pumps and a corresponding plurality of reservoir tanks, each of the plurality of pumps connected to one of the corresponding plurality of reservoir tanks.

10. The apparatus of claim 9 further comprising a plurality of nozzles positioned within the enclosure, each one of the plurality of pumps being connected to one of the plurality of nozzles positioned within the enclosure.

11. The apparatus of claim 1, wherein the apparatus comprises:
at least three diaphragm pumps; and
at least three reservoir tanks, each reservoir tank connected to a separate one of the at least three diaphragm pumps.

12. The apparatus of claim 11, wherein the first reservoir tank holds a sun screen lotion having an SPF in a range between 2 and 60, the second reservoir tank holds a chemically-active skin coloring lotion and the third reservoir tank holds a skin moisturizing lotion.

13. The apparatus of claim 12 further comprising a fourth pump connected to a rinse tank for applying a rinse solution inside the enclosure.

14. The apparatus of claim 1 further comprising a solenoid for controlling the check valve.

15. The apparatus of claim 14, wherein a microprocessor sends a signal to the solenoid for closing the check valve and interrupting delivery of the lotion to the spray nozzle.

16. The apparatus of claim 1 further comprising a housing enclosing the pump, check valve, reservoir tank and power source.

17. An apparatus for dispensing a lotion, the apparatus comprising:
a booth having a floor and at least one wall defining an enclosure;
a plurality of nozzles positioned within the enclosure;
a plurality of reservoir tanks for holding different solutions;
a plurality of pumps, each one of the plurality of pumps connected to one of the plurality of reservoir tanks and drawing one of the different solution from its respective reservoir tank and delivering each different solution to one of the plurality nozzles to apply the different solutions upon the user;
a plurality of solenoid activated check valves, each one of the plurality of solenoid activated check valves controlling solution flow from one of the plurality of pumps to one of the plurality of nozzles; and
a power source connected to the plurality of pumps.

18. The apparatus of claim 17, wherein the pumps are diaphragm pumps.

19. The apparatus of claim 17 further comprising a microprocessor for sending signals to the plurality of pumps and the plurality of solenoid activated valves.

20. The apparatus of claim 17 further comprising a payment acceptance system.

21. The apparatus of claim 20, wherein the payment acceptance system comprises a wireless transmitter.

22. The apparatus of claim 17, wherein the power source comprises a low voltage DC power source.

23. The apparatus of claim 17, wherein the apparatus is portable.

24. The apparatus of claim 17, wherein the apparatus is weatherproof.

25. The apparatus of claim 17 comprising five reservoir tanks, five pumps and three solenoid activated check valves.

26. The apparatus of claim 25 wherein the five reservoir tanks hold one of the following solutions: water, a disinfectant, a chemically-active skin colorant, a skin moisturizer, a sun screening lotion having an SPF in a range of between 2 and 60, and waste.
